(19) United States
(12) Patent Application Publication
(10) Pub. No.: US 2008/0078348 A1
(43) Pub. Date: Apr. 3, 2008

(54) Detachable starter box for remote-control toy car

(76) Inventor: Ke-Way Lu, Taipei City (TW)

Correspondence Address: Richard P. Berg;Ladas & Parry, Suite #2100, 5670 Wilshire Boulevard, Los Angeles, CA, 90036-5679, US

(21) Appl. No.: 11/542,351

(22) Filed: Oct. 2, 2006

(51) Int. Cl. F02N 17/00

(52) U.S. Cl. 123/179.1

(57) ABSTRACT

A detachable starter box includes two master racks, two links coupled between the master racks for enabling the master racks to be moved between a first position where the master racks are kept apart in a parallel manner at a distance and a second position where the master racks are attached to each other, two base members detachably coupled between the master racks at the bottom side, two lock screw for locking the links in the second position, two pairs of track assemblies respectively mounted on the master racks, each track assembly having a plurality of vertical bottom mounting rods vertically adjustably fastened to vertical columns of the master racks, two carriages respectively supported on the pairs of track assemblies for supporting a remote-control toy car, each carriage having a longitudinal bottom plate pivotally coupled to its one end to one pair of track assemblies and a transverse top plate movably coupled to the longitudinal bottom plate and movable along the longitudinal sliding tracks of the associating track assemblies, and four retaining members respectively coupled to the transverse top plates of the carriages and movable respectively along transverse sliding slots on the transverse top plates of the carriages for securing a remote-control toy car to the carriages.

### BACKGROUND OF THE INVENTION

1. Field of the Invention

The present invention relates to a starter box for remote-control toy car and, more particularly, to a detachable starter box that can be detached and arranged into a flat manner to reduce the size for carrying.

2. Description of the Related Art

Regular remote-control toy cars commonly use an electric starter to start the engine. To prevent the car from running out accidentally when started the engine, a starter box is used to support the car above the floor before starting the car.

FIG. 13 shows a conventional starter box A for this purpose. According to this design, the starter box A has two carrier plates A1 respectively slidably coupled to X-axis sliding slots A0 on the rigid starter box body thereof. By means of adjusting the respective position in the X-axis sliding slots A0, the pitch between the two carrier plates A1 is adjusted. Further, each carrier plate A1 has two retaining blocks A3 adjustable relative to each other in Y-axis direction for securing a toy car. Therefore, by means of adjusting the pitch between the two carrier plates A1 and the pitch between the two retaining blocks A3 of each carrier plate A1, the starter box A fits any of a variety of toy cars.

FIG. 14 shows another design of starter box B according to the prior art. According to this design, the starter box B has X-axis sliding slots B2 in the four corners, four retaining blocks B3 respectively slidably coupled to the X-axis sliding slots B2 for securing a toy car for starting, and a driving wheel B1 rotatable by a power drive inside the starter box. When a remote-control toy car is placed on the top side of the starter box B, the retaining blocks B3 are adjusted to secure the remote-control toy car firmly in place, and then the driving wheel B1 is started to rotate the flywheel of the remote-control toy car, thereby starting the engine of the remote-control toy car.

FIG. 15 shows still another design of starter box C according to the prior art. According to this design, the starter box C comprises a carrier plate C at the front side of the top wall, a plurality of sliding slots C3 formed on the carrier plate C and the rear side of the top wall and extending in X-axis direction, a plurality of retaining members C4 respectively movably mounted in the sliding slots C3 for securing a remote-control toy car for starting, and a driving wheel C1 for starting the engine of the remote-control toy car placed on the starter box C.

The aforesaid three prior art designs have a common drawback, i.e., the starter box body is rigid and not collapsible. Therefore, these conventional starter boxes require much storage space and are not convenient to carry.

### SUMMARY OF THE INVENTION

The present invention has been accomplished under the circumstances in view. It is the main object of the present invention to provide a starter box that can be detached and arranged into a flat manner to reduce the size for carrying. It is another object of the present invention to provide a detachable starter box that can easily be set up. It is still another object of the present invention to provide a detachable starter box that allows adjustment in height, length and width to secure any of a variety of remote-control toy cars firmly in position for starting.

To achieve these and other objects of the present invention, the detachable starter box comprises two base members, two master racks detachably fastened to the base members by a respective plug joint and arranged in parallel, two links coupled between the master racks for enabling the master racks to be moved, after disconnection of the master racks from the base members, between a first position where the master racks are kept apart in a parallel manner at a distance and a second position where the master racks are attached to each other, two lock screw members respectively mounted on the master racks corresponding to the mouthpieces of the links for locking the links in the second position, two pairs of track assemblies respectively mounted on the master racks, each track assembly having a horizontal plate member, a longitudinal sliding track fixedly provided at the top of the horizontal plate member, and a plurality of vertical bottom mounting rods respectively downwardly extending from the horizontal plate member and respectively inserted into the vertically extending coupling holes of the vertical columns of the master racks, two carriages respectively supported on the pairs of track assemblies for supporting a remote-control toy car, each carriage having a longitudinal bottom plate pivotally coupled to its one end to one pair of track assemblies and a transverse top plate movably coupled to the longitudinal bottom plate and movable along the longitudinal sliding tracks of the associating track assemblies, and four retaining members respectively coupled to the transverse top plates of the carriages and movable respectively along transverse sliding slots on the transverse top plates of the carriages for securing a remote-control toy car to the carriages.

When not in use, the carriages are turned in reversed directions relative to the master racks to disengage the respective bottom guide rods from the longitudinal sliding tracks of the track assemblies, and then the two master racks are moved toward each other and closely attached together, and the lock screw members are fastened to the mouthpieces of the links to lock the links in the second position, thereby reducing the size of the starter box. When in use, the lock screw members are loosened from the mouthpieces of the links, and then the two master racks are extended outwards, and then the carriages are turned to the top side of the master racks to couple to respective bottom guide rods to the longitudinal sliding tracks of the track assemblies.

Further, the upright columns of the master racks each have a plurality of horizontal locating holes respectively disposed in communication with the respective vertical coupling hole at different elevations, and the vertical bottom mounting rods of the track assemblies each have a plurality of vertically spaced mounting screw holes respectively selectively fastened to the horizontal locating holes of the upright columns with respective screws.

Further, the horizontal plate members of the track assemblies each are mounted with a respective mounting block. Further, the carriages each have a transverse pivot shaft coupled between the mounting blocks at the horizontal plate members of the associating pair of track assemblies.

Further, the transverse top plates of the carriages each have two bottom guide rods respectively coupled to the longitudinal sliding tracks of the associating track assemblies.

Further, the retaining members each have a polygonal bottom coupling rod respectively coupled to the respective transverse sliding slots of the transverse top plates of the carriages.

Further, the retaining members are dual-cone type retaining members each comprised of two cones fixedly connected in parallel, and the polygonal bottom coupling rod of each retaining member extends downwards from one cone of the respective retaining member. The polygonal bottom coupling rod of each retaining member can be rotated with the respective retaining member relative to the associating transverse top plate of the associating carriage to the desired angle and then inserted into the associating transverse sliding slot of the associating transverse top plate of the associating carriage.

### BRIEF DESCRIPTION OF THE DRAWINGS

FIG. 1 is an elevational view of a starter box according to the present invention.

FIG. 2 corresponds to FIG. 1, showing a chassis of a remote-control toy car secured to the starter box.

FIG. 3 is an exploded view of the starter box according to the present invention.

FIG. 4 is a schematic drawing showing the starter box collapsed.

FIG. 5A is a side view of the first master rack of the starter box according to the present invention.

FIG. 5B is a side view of the second master rack of the starter box according to the present invention.

FIG. 6 is a top view of the starter box according to the present invention.

FIG. 7 is a bottom view of the present invention, showing a chassis of a remote-control toy car secured to the starter box.

FIG. 8 is a top plain view of the present invention, showing a chassis of a remote-control toy car secured to the starter box.

FIG. 9 is a top plain view showing the collapsed status of the starter box according to the present invention.

FIG. 10 is an exploded plain view of starter box according to the present invention.

FIG. 11 is a top plain view of the present invention before connection of the links between the two master racks.

FIG. 12 is a schematic drawing showing an application example of the present invention.

FIG. 13 is an oblique elevation of a starter box according to the prior art.

FIG. 14 is an oblique elevation of another design of starter box according to the prior art.

FIG. 15 is an oblique elevation of still another design of starter box according to the prior art.

### DETAILED DESCRIPTION OF THE INVENTION

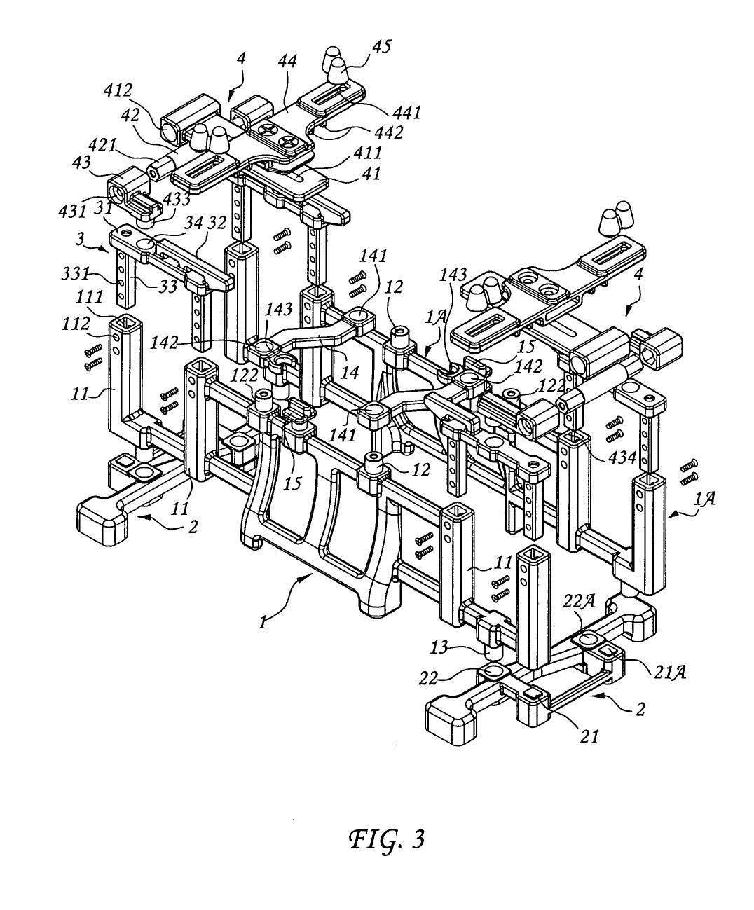

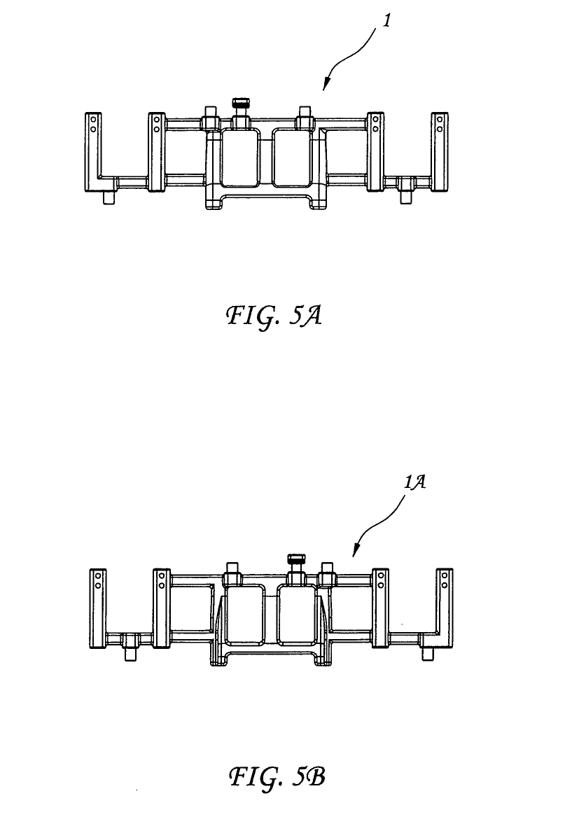

Referring to FIGS. 3, 5A and 5B, a detachable starter box for remote-control toy car in accordance with the present invention is shown comprising two master racks 1 and 1A, two links 14, two base members 2, four track assemblies 3, and two carriages 4.

The base members 2 each have two vertical axle holes 22 and 22A and two upright locating blocks 21 and 21A.

The master racks 1 and 1A are respectively formed of rectangular frame tubes. Further, the master racks 1 and 1A each comprise two bottom shanks 13 and two bottom mounting holes (not shown) corresponding to the vertical axle holes 22 and 22A and upright locating blocks 21 and 21A of the base members 2, a plurality of upright columns 11, each upright column 11 having a vertical coupling hole 111 vertically extending out of the topmost edge and a plurality of horizontal locating holes 112 respectively disposed in communication with the vertical coupling hole 111 at different elevations, a first top pivot axle 12 and a second top pivot axle 122, and a lock screw 15 at the top. By means of inserting the bottom shanks 13 of the master racks 1 and 1A into the vertical axle holes 22 and 22A of the base members 2 to force the upright locating blocks 21 and 21A of the base members 2 into the bottom mounting holes of the master racks 1 and 1A, the master racks 1 and 1A and the base members 2 are firmly secured together.

The two links 14 are yoke members detachably coupled between the two master racks 1 and 1A, each having two pivot holes 141 and 142 respectively coupled to the first top pivot axles 12 and second top pivot axles 122 of the two master racks 1 and 1A. The two links 14 each further have a mouthpiece 143. When the detachable starter box is detached, the mouthpiece 143 of the links 14 can be respectively attached to the lock screws 15 of the two master racks 1 and 1A and respectively locked to the master racks 1 and 1A by the lock screws 15.

The four track assemblies 3 are identical and arranged in two sets respectively detachably mounted on the two master racks 1 and 1A at the front and rear sides, each comprising a horizontal plate member 31, a longitudinal sliding track 32 fixedly provided at the top side of the horizontal plate member 31 and extending in longitudinal direction corresponding to the length of the master racks 1 and 1A, and a plurality of vertical mounting rods 33 perpendicularly downwardly extending from the bottom side of the horizontal plate member 31 and respectively insertable into the vertical coupling hole 111 of the upright columns 11 of the two master racks 1 and 1A. The horizontal plate member 31 of each track assembly 3 has a pivot hole 34. The vertical mounting rods 33 each having a plurality of vertically spaced mounting screw holes 331 selectively fastened to the horizontal locating holes 112 of the upright columns 11 of the two master racks 1 and 1A with screws to secure the respective track assemblies 3 to the master racks 1 and 1A at the desired elevation.

The two carriages 4 respectively adjustably coupled to the track assemblies 3 above the master racks 1 and 1A, each comprising a longitudinally extending bottom plate 41 and a transversely extending top plate 44. The bottom plate 41 has a longitudinal sliding groove 411, and a transversely extending pivot hole 412. A transverse shaft 42 is inserted through the pivot hole 412 of the bottom plate 41. The transverse shaft 42 has a polygonal coupling rod 421 at each of the two distal ends to hold a respective mounting block 43. The mounting block 43 has a polygonal coupling hole 431 coupled to one polygonal coupling rod 421, a bottom axle 433 inserted into the pivot hole 34 of the horizontal plate member 31 of one track assembly 3, a bottom stop member 434 stopped at a part of the horizontal plate member 31 of the associating track assembly 3, and a longitudinal sliding rail 432. Thus, the bottom plate 41 is turnable about the associating transverse shaft 42. The top plate 44 is coupled to bottom plate 41 and movable along the longitudinal sliding groove 411, having two transverse sliding slots 441 aligned in a line near the two distal ends, two dual-cone type retaining members 45 respectively coupled to the transverse sliding slots 441 for securing a remote-control toy car to the respective carriage 4, and two bottom guide rods 442 respectively coupled to the longitudinal sliding tracks 32 of the associating two track assemblies 3. The two dual-cone type retaining members 45 each have two fixed cones arranged in parallel and a polygonal bottom coupling rod downwardly extending from one cone and respectively coupled to the respective transverse sliding slots 441. The dual-cone type retaining members 45 can be moved along the respective transverse sliding slots 441 to adjust the pitch subject to the width of the remote-control toy car to be started. Further, the dual-cone type retaining members 45 can be respectively rotated relative to the top plate 44 to the desired angle for securing the loaded remote-control toy car firmly in place.

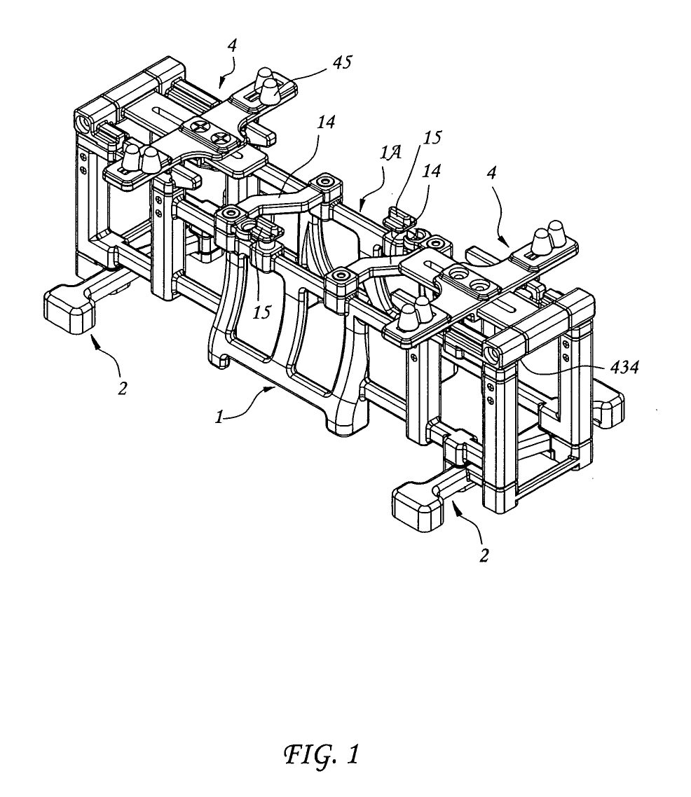

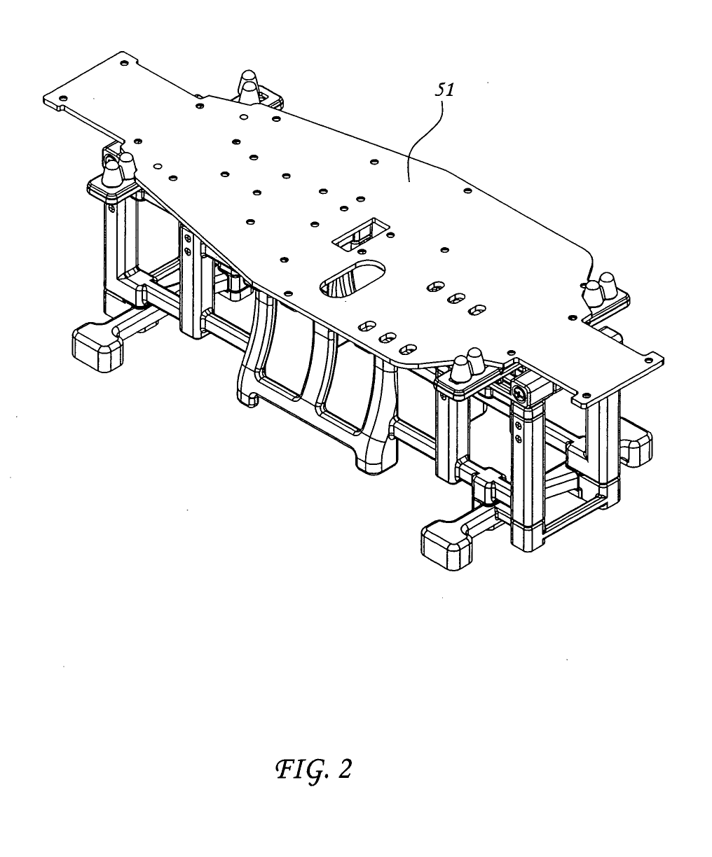

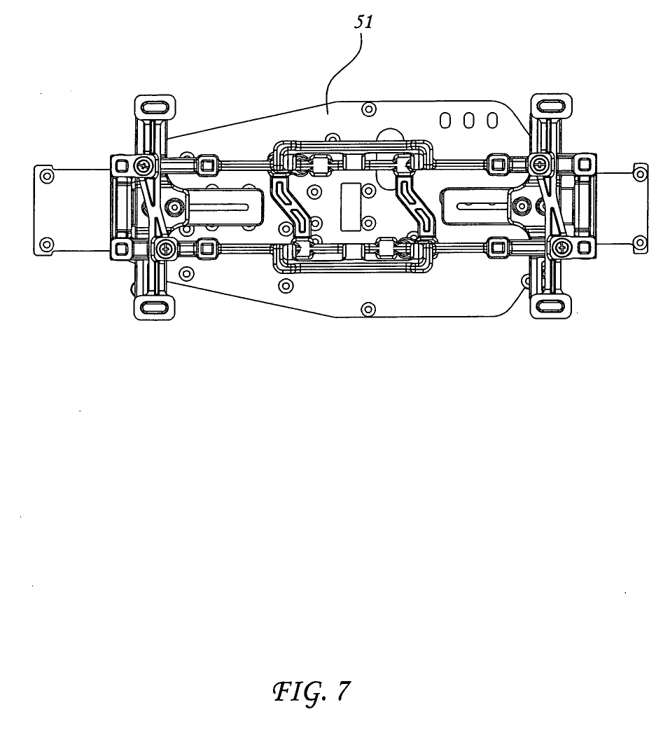

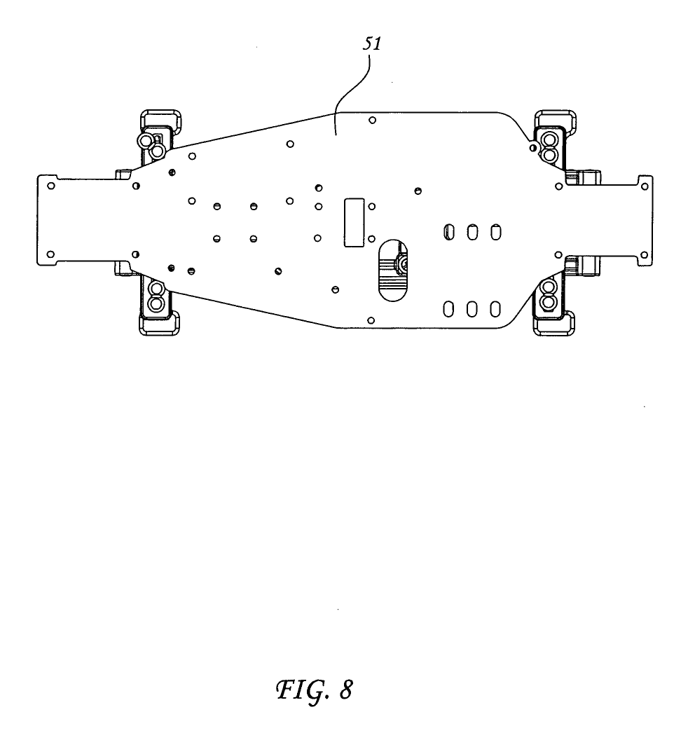

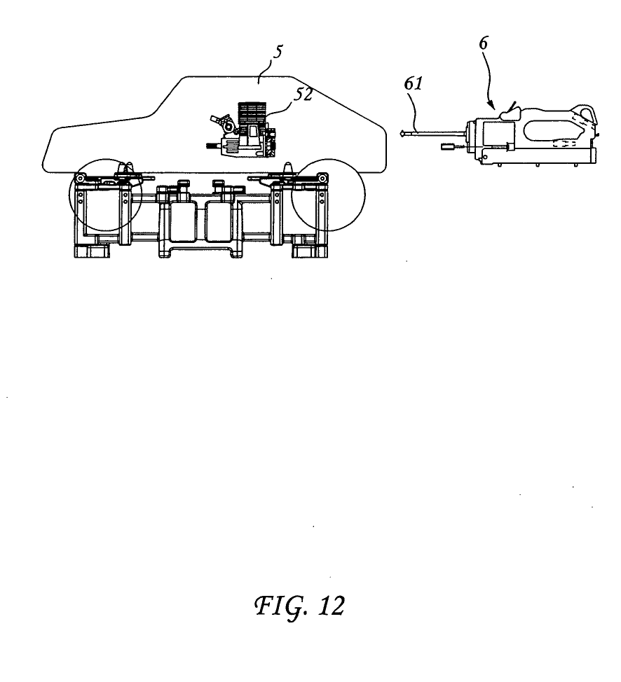

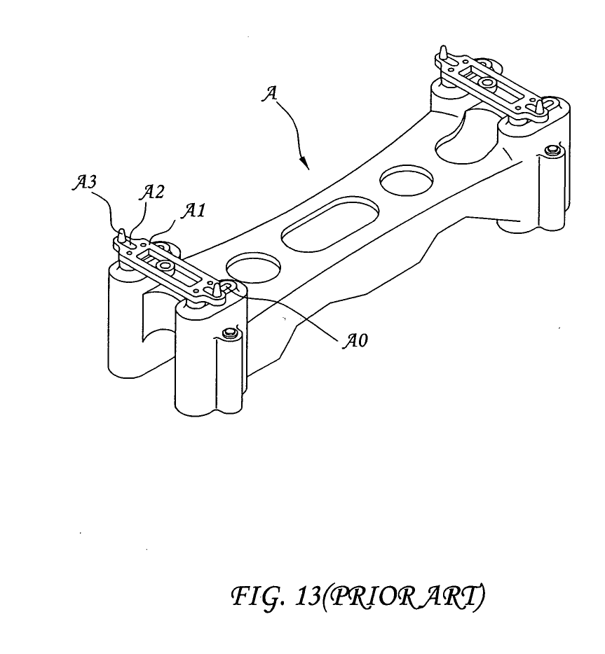

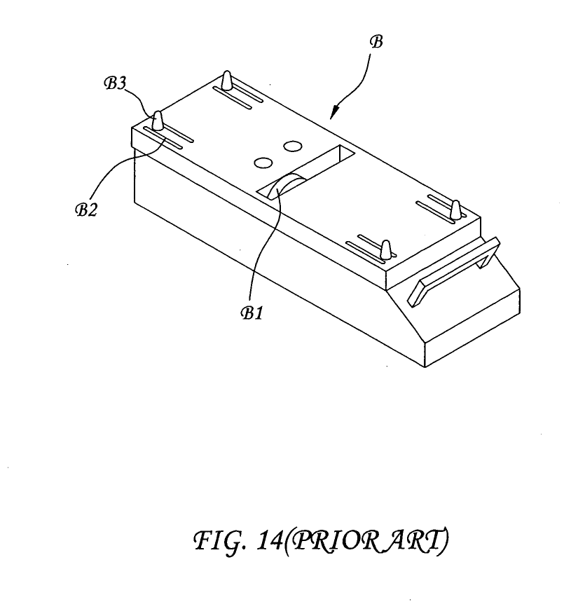

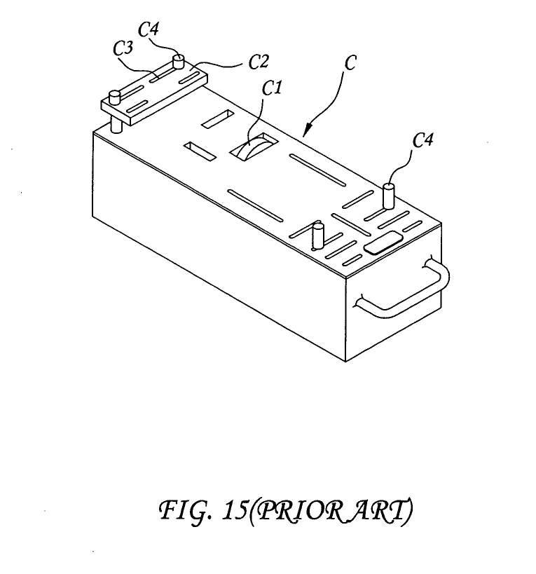

FIG. 1 shows the starter box assembled. When in use, the remote-control toy car 5 to be started is placed on the starter box and secured in place by the retaining members 45 (see FIGS. 2, 7, 8 and 12). At this time, the driving rod 61 of an electric engine starter 6 is coupled to the engine 52 of the remote-control toy car 5, and then the electric engine starter 6 is turned on to rotate the driving rod 61, thereby starting the engine 52 of the remote-control toy car 5.

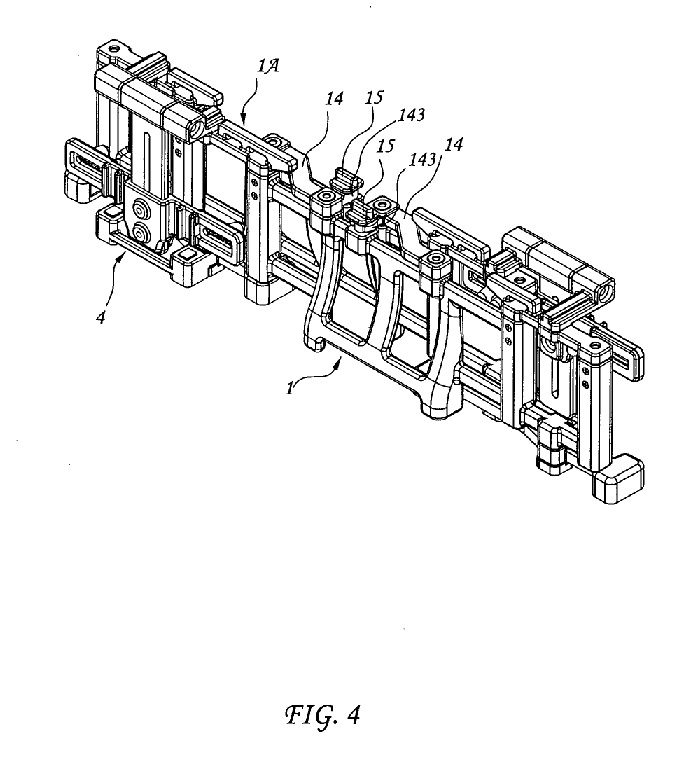

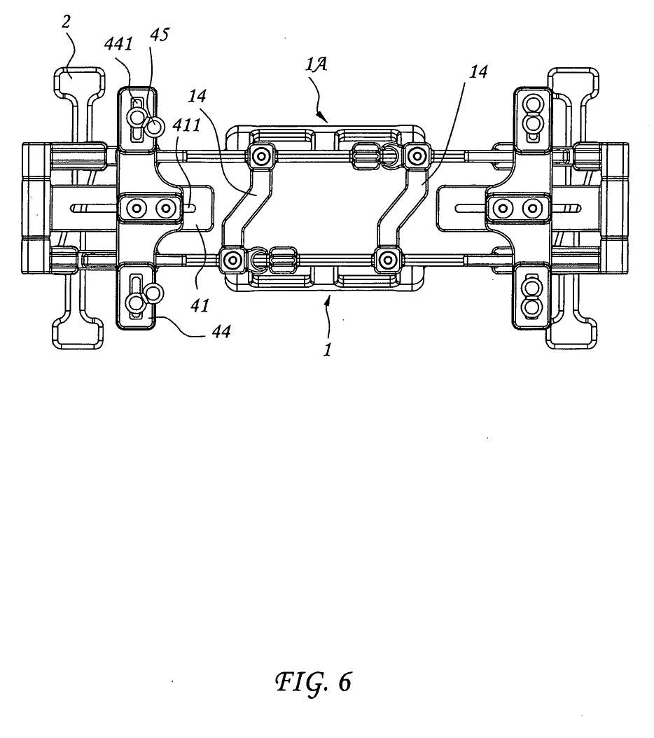

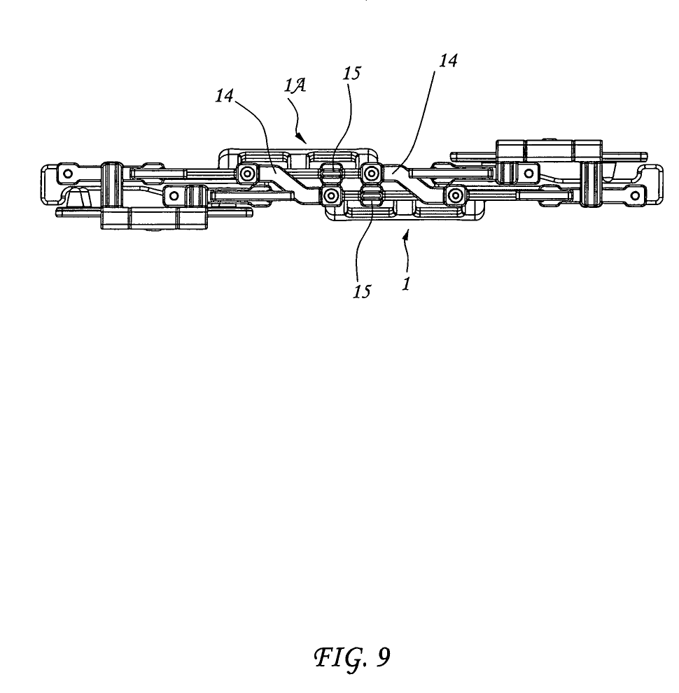

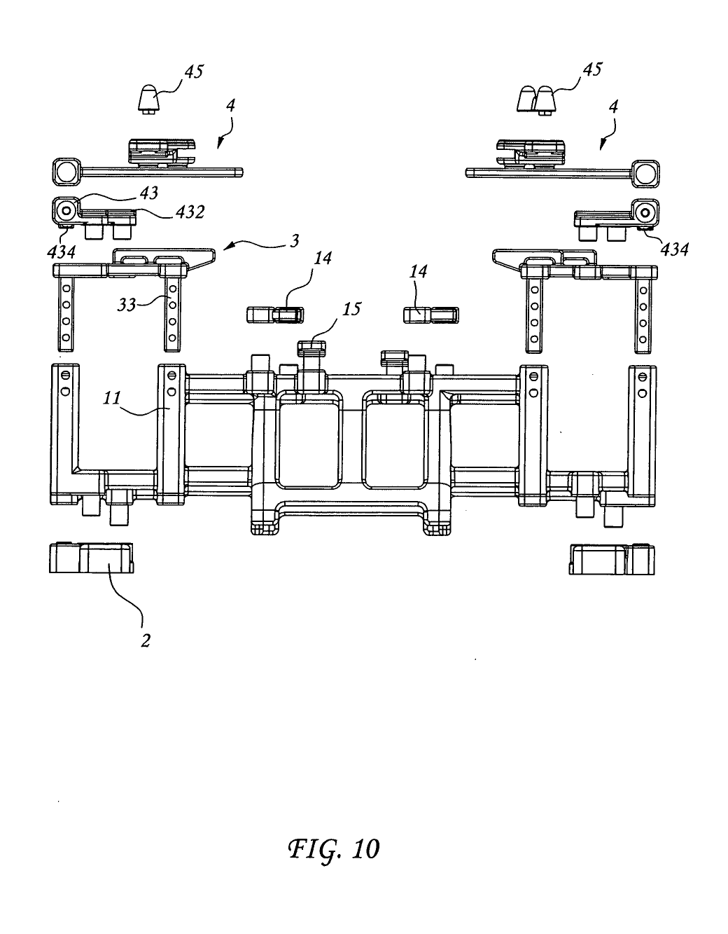

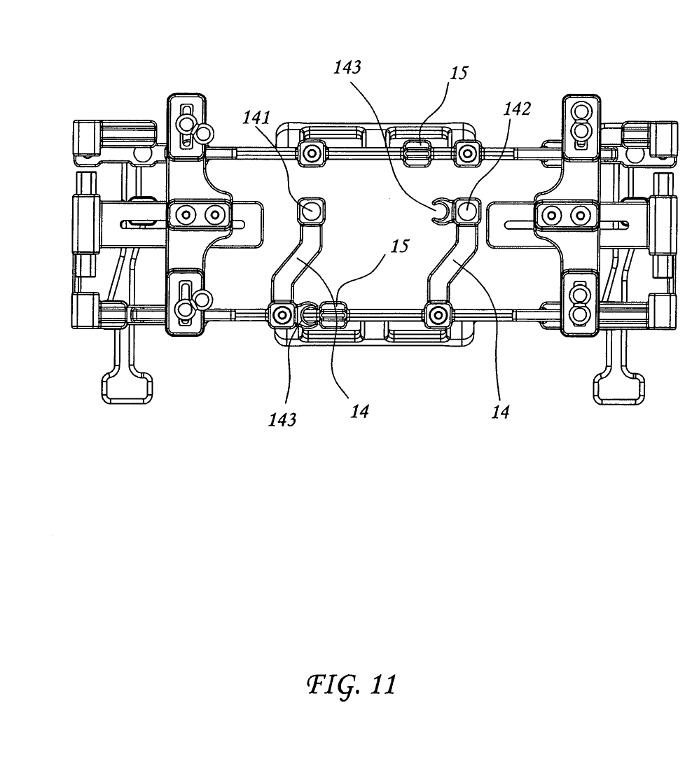

When not in use, the two master racks 1 and 1A are respectively disconnected from the vertical axle holes 22 and 22A and upright locating blocks 21 and 21A of the base members 2, and then the two carriages 4 are turned in reversed directions to disengage the respective bottom guide rods 442 from the longitudinal sliding tracks 32 of the associating two track assemblies 3 for enabling the two master racks 1 and 1A to be moved toward each other and closely attached together, and then the lock screws 15 are fastened tight to lock the links 14, keeping the two master racks 1 and 1A closely attached together (see FIGS. 4 and 9). Thus, the size of the starter box is greatly reduced and convenient for carrying. When in use, the two master racks 1 and 1A are moved apart and then the links 14 are connected between the two master racks 1 and 1A to hold them in the extended position (see FIGS. 6 and 11), and then the two base members 2 are fastened to the master racks 1 and 1A, and then the two carriages 4 are turned to the top side of the master racks 1 and 1A. Further, the user can adjust the elevation of the track assemblies 3 relative to the master racks 1 and 1A and also adjust the position of the top plates 44 relative to the associating bottom plates 41 and the position of the retaining members 45 relative to the associating top plates 44 subject to the size of the remote-control toy car to be started, enabling the retaining members 45 to secure the loaded remote-control toy car firmly in place for starting.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A starter box comprising:
two base members, said base members each having two top axle holes;
two master racks detachably fastened to said base members in parallel, said master racks each having two bottom shanks respectively fastened to the top axle holes of said base members, a first top pivot axle and a second top pivot axle, and a plurality of upright columns, said upright columns each having a vertically extending coupling hole;
two links coupled between said master racks for enabling said master racks to be moved, after disconnection of said master racks from said base members, between a first position where said master racks are kept apart in a parallel manner at a distance and a second position where said master racks are attached to each other, said links each having a pivot hole disposed at each of two distal ends thereof and respectively coupled to the first top pivot axles and second top pivot axles of said master racks and a mouthpiece at one of the two distal ends;
two lock screw members respectively mounted on said master racks corresponding to the mouthpieces of said links for locking said links in said second position;
two pairs of track assemblies respectively mounted on said master racks, said track assemblies each having a horizontal plate member, a longitudinal sliding track fixedly provided at a top side of said horizontal plate member, and a plurality of vertical bottom mounting rods respectively downwardly extending from said horizontal plate member and respectively inserted into the vertically extending coupling holes of the vertical columns of said master racks;
two carriages respectively supported on said pairs of track assemblies for supporting a remote-control toy car, said carriages each having a longitudinal bottom plate and a transverse top plate, said longitudinal bottom plate having one end pivotally coupled to one of said two pairs of track assemblies, said transverse top plate being movably coupled to said longitudinal bottom plate and movable along the longitudinal sliding tracks of the associating track assemblies, said transverse top plate having two transverse sliding slots aligned in a line; and
four retaining members respectively coupled to the transverse top plates of said carriages and movable respectively along the transverse sliding slots of the transverse top plates of said carriages for securing a remote-control toy car to said carriages.

2. The starter box as claimed in claim 1, wherein said base members each further have two upright locating blocks; said two master racks each have two bottom mounting holes for receiving the upright locating blocks of said base members.

3. The starter box as claimed in claim 1, wherein said upright columns each have a plurality of horizontal locating holes respectively disposed in communication with the respective vertical coupling hole at different elevations; the vertical bottom mounting rods of said track assemblies each have a plurality of vertically spaced mounting screw holes respectively selectively fastened to the horizontal locating holes of said upright columns with respective screws.

4. The starter box as claimed in claim 1, wherein the horizontal plate members of said track assemblies each are mounted with a respective mounting block; said carriages each have a transverse pivot shaft coupled between the mounting blocks at the horizontal plate members of the associating pair of track assemblies.

5. The starter box as claimed in claim 1, wherein the transverse top plates of said carriages each have two bottom guide rods respectively coupled to the longitudinal sliding tracks of the associating track assemblies.

6. The starter box as claimed in claim 1, wherein said retaining members each have a polygonal bottom coupling rod respectively coupled to the respective transverse sliding slots of the transverse top plates of said carriages.

7. The starter box as claimed in claim 6, wherein retaining members are dual-cone type retaining members each comprised of two cones fixedly connected in parallel; the polygonal bottom coupling rod of each of said two retaining members extends downwards from one of the two cones of the respective retaining member.

8. The starter box as claimed in claim 4, wherein the mounting blocks at the horizontal plate members of said track assemblies each have a bottom stop member stopped at a part of the horizontal plate member of the associating track assemblies.
